(19) United States
(12) Patent Application Publication
(10) Pub. No.: US 2020/0053621 A1
(43) Pub. Date: Feb. 13, 2020

(54) Network Node and Method for Activation of Mobility Procedure in Wireless Communication Network

(71) Applicant: Telefonaktiebolaget LM Ericsson (publ), Stockholm (SE)

(72) Inventors: Andres Reial, Malmö (SE); Gunnar Bark, Linköping (SE)

(21) Appl. No.: 16/340,562

(22) PCT Filed: Oct. 10, 2016
(86) PCT No.: PCT/EP2016/074181

§ 371 Date: Apr. 9, 2019

(51) Int. Cl. H04W 36/32; H04W 84/04; H04W 36/30; H04W 36/00; H04B 7/06

(52) U.S. Cl. CPC H04W 36/32; H04W 84/047; H04B 7/0695; H04W 36/0009; H04W 36/0083; H04W 36/30

(57) ABSTRACT

A network node (120, 122, 130, 140) and method therein for activation of mobility procedure for a wireless communication device (130) in a wireless communication network (100) are disclosed. The network node (120, 122, 130, 140) is configured to obtain movement status information of the wireless communication device (130) and activate mobility procedure based on the movement status information.

### TECHNICAL FIELD

Embodiments herein relate to a network node, a wireless communication device and methods therein. In particular, they relate to activation of mobility procedure in a wireless communication network.

### BACKGROUND

Handover is an important part of any wireless communication systems or networks. In legacy systems or networks, such as Global System for Mobile Communications (GSM) networks, Wideband Code Division Multiple Access (WCDMA) or High Speed Packet Access (HSPA) networks, 3G Long Term Evolution (LTE) networks, a wireless communication network covers a geographical area which is divided into cell areas. Each cell area is served by a base station, which may also be referred as an access node. A wireless communication network may include a number of cells that can support communications for a number of wireless communication devices or user equipments (UE). A user equipment may communicate with a serving access node in a serving cell and may need to make measurements of other cells for various purposes, such as handover. Handover is a process of transferring an ongoing connection of a UE from one cell, i.e. the serving cell, to another cell, i.e. the target cell, in order to accomplish a transparent service over a larger area. The handover should happen without any loss of data and with as small interrupt as possible.

To enable a handover, it is necessary to find a suitable target cell, and to ensure that it is possible to sustain reliable communication with that target cell. Candidates for suitable target cell are usually stored in so-called neighbor lists, which are stored at least at the serving access node. To make sure that it is possible to sustain reliable communication with the target cell, the connection quality in the target cell needs to be estimated before the handover can take place.

The quality of the target cell is estimated by measurements related to the link quality to the UE. Both downlink (DL) or uplink (UL) measurements can be considered. In UL measurement-based approaches, the UE transmits a suitable Reference Signal (RS) in the UL, candidate cells' access nodes measure their respective link qualities, and the network determines whether a handover is necessary. Relying solely on uplink measurements can be unreliable, since the uplink connection quality can be different from the corresponding downlink connection quality. Therefore, handovers in cellular systems are also often based on downlink measurements. In a DL measurement-based approach, the network transmits RSs from candidate access nodes, the UE measures the candidate access nodes' signal strength, and reports back to the network where the handover decision is made.

In legacy systems, all base stations continuously transmit pilot signals that UEs in neighbor cells use to estimate the target cell quality. This is true in GSM, where Broadcast Control Channel (BCCH) messages are sent, in WCDMA, where Common Pilot Channel (CPICH) signals are sent, and in LTE, where Cell-Specific Reference Signal (CRS) is used, as well as in WiFi, where Beacon frames are transmitted. This makes it possible to estimate the quality of neighbor cells with relatively good accuracy. The UEs does measurements periodically and reports the measurements to the network. If it is detected that the serving cell signal power or quality is getting close to another candidate cell power or quality, a more detailed measurement process or a handover procedure may be initiated.

Modern cellular systems, such as 5G systems, will use advanced antenna array systems to a large extent. With such antenna arrays, signals will be transmitted in narrow beams to increase signal strength in some directions, and/or to reduce interference in other directions. When the antenna array is used to increase coverage, the serving and target cell access node identities are no longer sufficient for maintaining seamless connections. Handover management between narrow beams in neighboring base stations becomes a necessity, and the serving base station also needs to decide if a beam switch or beam update is necessary within the own cell. In general, it may be expected that more handovers will occur in modern cellular systems based on narrow beam forming. The beam through which the base station is currently communicating with the UE is similarly called the serving beam and the beam it will hand over or switch to is called the target beam.

Applying the principle of continuous transmission of pilot signals in all individual beams for continuous measurements in a modern cellular system may be convenient for UEs, but serious problems are created for the network. Continuous pilot transmission generates a lot of interference in neighbor cells and consumes network capacity which otherwise is available for data. It also leads to higher power consumption in the base stations, since long Discontinuous Transmission (DTX) periods become impossible. In a system relying on advanced antenna arrays with narrow beams to improve coverage, it is thus deemed impractical to transmit pilot signals in all beams at all times.

To enable efficient handover or beam switching procedures, the network thus must avoid handover procedures that rely on continuous pilot signal transmissions and continuous measurements. Furthermore, with very narrow beams, the hand-over procedure needs to be very fast. Therefore any additional measures and signaling to trigger the hand-over procedure will increase the risk of beam hand-over failure.

### SUMMARY

It is therefore an object of embodiments herein to provide an improved mobility procedure in a wireless communication network.

According to a first aspect of embodiments herein, the object is achieved by a method performed in a network node in a wireless communication network for activation of mobility procedure for a wireless communication device. The network node obtains movement status information of the wireless communication device, and activates mobility procedure based on the movement status information.

According to a second aspect of embodiments herein, the object is achieved by a network node for activation of mobility procedure for a wireless communication device in a wireless communication network. The network node is configured to obtain movement status information of the wireless communication device, and activate mobility procedure based on the movement status information.

According to the embodiments herein, the network node may be any one of a serving access node, a non-serving access node, a network controller or a wireless communication device.

According to some embodiments, the network node is further configured to obtain mobility measurement information and initiate a serving link change for the wireless communication device based on the mobility measurement information. The serving link may be referred to as any cell, beam, sector, node etc. which servers the wireless communication device via a communication link.

An idea of the embodiments herein is that the mobility procedure for a given wireless communication device is triggered when a physical movement of the wireless communication device is detected. Responsive to the trigger, relevant mobility measurement signals are transmitted and measurements are performed. In one embodiment, the mobility procedure may be trigged by the wireless communication device when it detects a movement. In this case, the mobility procedure may comprise activating and sending an uplink mobility measurement signal from the wireless communication device to the network node or activating measurement report to the network node in case downlink mobility measurement signals are ready or always on. Alternatively, the network node may detect or the wireless communication device may signal its physical movement information to the network node, so the mobility procedure may be trigged by the network node based on the movement status information of the wireless communication device. In this case, the mobility procedure may comprise sending downlink mobility measurement signals to the wireless communication device, or ordering the wireless communication device to turn on uplink measurement signals, or requesting the wireless communication device to send measurement report in case downlink mobility measurement signals are already or always on. Based on the measurement results, a handover or a beam switch may be executed to handover to a new target node or switch to a new target beam.

Since the activation of mobility procedure according to the embodiments herein, i.e. mobility measurement signals transmission and measurements, for a certain wireless communication device is based on the wireless communication device transitions from a static sate to a moving state, it does not depend on the availability of monitoring signals or reliable reference data about expected signal quality levels.

The embodiments herein provide a fast and reliable mechanism for triggering of on-demand mobility measurement signal transmission, measurements and reporting, without requiring ongoing serving beam quality monitoring and without relying on assumptions or prior statistics about reference signal levels.

Since many wireless communication devices in the wireless communication network are typically static, and the measurement signals load associated with those that are moving may be limited to a level that is appropriate for their degree of mobility. This will also generate less interference in the wireless communication network.

Therefore the embodiments herein provide an improved mechanism for the mobility procedure and achieve the benefits of a lean on-demand measurement reference signal activation principle.

### BRIEF DESCRIPTION OF THE DRAWINGS

Examples of embodiments herein are described in more detail with reference to attached drawings in which:

FIG. 1 is a schematic block diagram illustrating embodiments of a wireless communication network;

FIG. 2 is a schematic diagram illustrating beam directions of access nodes;

FIG. 3 is a flowchart depicting one embodiment of a method in a network node;

FIG. 4 is a schematic block diagram illustrating embodiments of a network node; and

FIG. 5 is a schematic block diagram illustrating embodiments of a wireless communication device.

### DETAILED DESCRIPTION

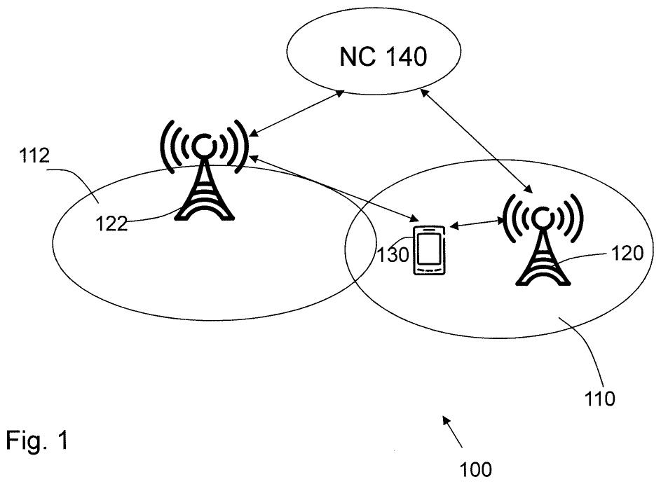

FIG. 1 depicts an example of a wireless communication network 100 in which embodiments herein may be implemented. The wireless communication network 100 may be any wireless system or cellular network, such as a Long Term Evolution (LTE) network, any 3^{rd} Generation Partnership Project (3GPP) cellular network, Worldwide interoperability for Microwave Access (Wimax) network, Wireless Local Area Network (WLAN/Wi-Fi), a Fourth Generation (4G) network, a Fifth Generation (5G) cellular network etc.

The wireless communication network 100 comprises a plurality of cells whereof two, a first cell 110 comprising a first Access Node (AN) 120 and a second cell 112 comprising a second Access Node 122, are depicted in FIG. 1. The first Access Node 120, the second Access Node 122 are network access nodes which each may be, for example, an eNB, an eNodeB, or an Home Node B, an Home eNode B, a Relay, or any other network access node capable to serve a wireless communication device, such as a user equipment or a machine type communication device in a wireless communication network. The first Access Node 120 serves the first cell 110, while the second Access Node 122 serves the second cell 112.

A wireless communication device 130 operates in the wireless communication network 100. The first Access Node 120 is a serving AN serving the wireless communication device 130, the second Access Node 122 is a target AN for the wireless communication device 130.

The wireless communication device 130 may be a user equipment, a mobile wireless terminal or a wireless terminal, a mobile phone, a computer such as e.g. a laptop, a Personal Digital Assistants (PDAs) or a tablet computer, sometimes referred to as a phablet, with wireless capability, a sensor or actuator with wireless capabilities or any other radio network units capable to communicate over a radio link in a wireless communication network.

The wireless communication network may further comprise a Network Controller 140 which communicates with the first and second access nodes and acts as a handling unit or a controller for different Radio Access Technologies.

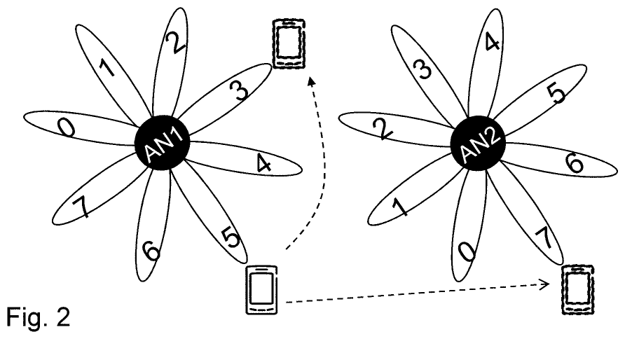

FIG. 2 shows beam directions for the first access node referred to as AN1 and being the serving access node 120, and the second access node referred to as AN2 and being the target access node 122. For example, AN1 has 8 beam directions, wherein Direction 5 is a beam direction towards the wireless communication device 130. If the wireless communication device 130 moves to another position, e.g. a position towards which beam Direction 3 of AN1 is directed, or a position towards which beam Direction 7 of AN2 is directed, a beam switch may be necessary. Therefore mobility procedure for the wireless communication device 130 may be triggered when a physical movement of the wireless communication device is detected. Responsive to the trigger, relevant mobility measurement signals are transmitted and measurements are performed.

According to embodiments herein, the mobility procedure may be activated by any access node, such as e.g. the serving access node 120, the target access node 122 or non-serving access node, the network controller 140, or by the wireless communication device 130. The mobility measurements may also be performed by any of the serving access node 120, the target access node 122 or non-serving access node, the network controller 140 or by the wireless communication device 130. However, the common idea of mobility procedure activation for the wireless communication device 130 is based on the physical movement of the wireless communication 130. Therefore a general term “a network node” is used hereafter to represent the access nodes 120, 122, the network controller 140 and the wireless communication device 130.

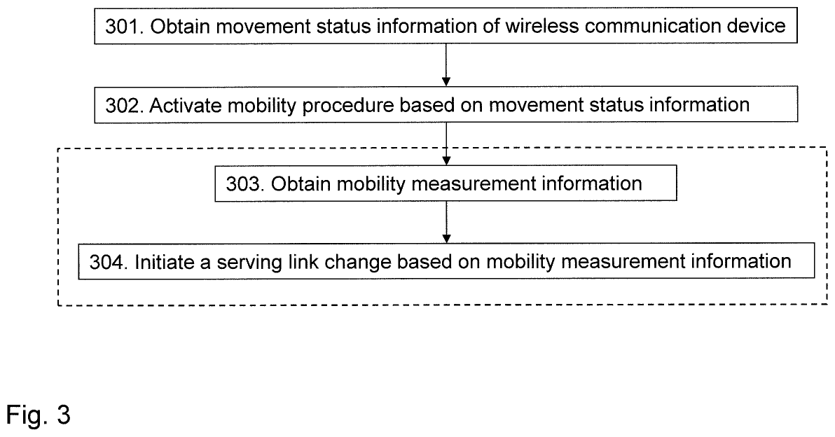

Example of embodiments of a method performed in a network node in the wireless communication network 100 for activation of mobility procedure for the wireless communication device 130 will now be described with reference to FIG. 3. As described above, the wireless communication network 100 comprises a plurality of access nodes 120, 122, where the access node 120 is the serving access node communicates with the wireless communication device 130 through a serving link. The serving link may be referred to as any cell, beam, sector, node etc., which servers the wireless communication device 130 via a communication link. The method comprises the following actions:

Action 301

The network node 120, 122, 130, 140 obtains movement status information of the wireless communication device 130. It is assumed that the serving access node 120 has set up movement monitoring control for the wireless communication device 130. That is, the mechanisms for controlling and/or signaling the wireless communication device 130 movement status are configured. The configuration may include measurements done by the wireless communication device 130 and/or by the network side, predefined thresholds, measurement rates, etc.

According to some embodiments, the movement status information may be any one of a static state, a movement state, or a mobility extent indicator such as a Doppler spread or a vehicular speed. In the following, we use the term mobility extent indicator, examples of which are Doppler spread or vehicular speed, to cover all forms of quantitative measures that describe the rate of change of channel estimates, device position estimates, etc.

As described above, according to some embodiments, the mobility procedure may be activated by the serving access node 120, the target access node 122 or non-serving access node or the network controller 140.

There are several alternatives to perform Action 301 when the mobility procedure is to be activated by the network node 120/122/140:

According to one embodiment, the network node 120/122/140 may obtain the movement status information by receiving it from the wireless communication device 130. The wireless communication device 130 may detect its movement and signal the start of physical movement to the network node 120/122/140, e.g. via layer 1 (L1) or Radio Resource Control (RRC) signaling.

According to one embodiment, the network node 120/122/140 may obtain the movement status of the wireless communication device 130 by determining it based on channel estimates of received signals from the wireless communication device 130. For example, the uplink channel estimates in the serving access node 120 baseband may be used to determine the Doppler spread and the associated vehicular speed of the wireless communication device 130.

According to one embodiment, the network node 120/122/140 may obtain the movement status of the wireless communication device 130 by determining it based on signal strength measurement reports with regard to one or more network access nodes received from the wireless communication device 130. The movement status may be determined e.g. by comparing subsequent signal strength measurement reports and detecting changes in absolute or relative signal strengths of the one or more network access nodes.

According to one embodiment, the network node 120/122/140 may determine movement status of the wireless communication device 130 based on timing advance estimates of the wireless communication device 130 with regard to one or more network access nodes. The movement status may be determined e.g. by comparing subsequent timing advance estimates and detecting changes in absolute timing advance values or timing advance differences for the one or more network access nodes. That is, the network node 120/122/140 may use available signal strength quality measurement reports of the wireless communication device 130 with regard to one or more access nodes or timing advance (TA) estimates to determine whether the wireless communication device is static or moving, and how rapidly. If changes in those values are detected that exceed a threshold, the device is categorized as moving, and the rate of change of these values is used to estimate the movement speed, or the mobility extent.

According to some embodiments, the mobility procedure may be activated by the wireless communication device 130, i.e. the network node is the wireless communication device 130. Then Action 301 is performed by the wireless communication device 130 by detecting movement status in the wireless communication device 130.

According to some embodiments, the wireless communication device 130 may detect a change in position, speed, or in environmental or proximity parameters of the wireless communication device 130. The wireless communication device 130 may use its built-in sensors such as accelerometers, gyroscopes, optical and electrical sensors, or other sensors, to detect its movement status or movement extent.

According to some embodiments, the wireless communication device 130 may detect movement status based on received signals from an access node, e.g. the serving access node 120 or any other non-serving access node.

According to some embodiments, the wireless communication device 130 may determine any one of a Doppler spread or a vehicular speed, a static or a movement state, based on down link channel estimates in the wireless communication device 130. That is, the DL channel estimates in the wireless communication device 130 baseband may be used to determine the Doppler spread and/or the static/moving status or the associated vehicular speed of the wireless communication device 130.

Action 302

The network node 120, 122, 140, 130 activates a mobility procedure based on the movement status information.

When the movement status information indicates a movement or when the mobility extent indicator is above a predefined threshold, the mobility procedure is activated.

The predefined threshold may be a vehicular speed threshold or a Doppler spread threshold.

So in Action 302, it is determined whether there is a movement of the wireless communication device 130 that justifies triggering the mobility procedure. The criterion may be e.g. that any movement of the wireless communication device 130 is detected or that the vehicular speed or Doppler spread of the wireless communication device 130 is above a predefined threshold. The predefined threshold may depend on the wireless communication device position in the serving beam or access node coverage area.

There are several alternatives to perform Action 302 when the mobility procedure is activated by the network node 120/122/140:

According to one embodiment, the network node 120/122/140 may send a downlink mobility measurement signal to the wireless communication device 130.

According to one embodiment, the network node 120/122/140 may order the wireless communication device 130 to transmit an uplink mobility measurement signal.

According to one embodiment, the network node 120/122/140 may receive an uplink mobility measurement signal from the wireless communication device 130. In this embodiment, the wireless communication device 130 detects its own movement and sends an uplink mobility measurement signal to the wireless communication network 100. When the network node 120/122/140 detects or receives this uplink mobility measurement signal, corresponding mobility procedure is activated.

According to one embodiment, the network node 120/122/140 may request the wireless communication device 130 to send measurement report in case the downlink mobility measurement signals are already or always on.

There are several alternatives to perform Action 302 when the mobility procedure is activated by the wireless communication device 130:

According to one embodiment, the wireless communication device 130 may send an uplink mobility measurement signal when the detected movement status indicates a movement or when the mobility extent indicator is above a predefined threshold.

In case downlink mobility measurement signals are always on, the wireless communication device 130 may activate measurement reporting to the network node 120/122/140.

After the mobility procedure is activated, in order to see if handover or beam switch is necessary, the network node 120/122/140 may further perform the following actions.

Action 303

The network node 120/122/140 may obtain mobility measurement information.

According to one embodiment, the network node 120/122/140 may receive mobility measurement information from the wireless communication device 130. In this case, the network node 120/122/140 transmits a downlink (DL) measurement signal, and optionally an order for the wireless communication device 130 to perform and report measurements. If no such order is transmitted, the wireless communication device 130 may be previously configured to measure and report upon detecting DL measurement signal transmission. This is referred to as DL measurement-based mobility procedure.

According to one embodiment, the network node 120/122/140 may measure the uplink mobility measurement signal received from the wireless communication device 130. In the case, when the network node 120/122/140 sends an order to the wireless communication device 130 to transmit uplink measurement signal, the uplink measurement signal configuration may be conveyed in the order, or via an earlier configuration. The wireless communication device 130 transmits the uplink measurement signal according to the order, and the network node 120/122/140 performs measurements on the uplink measurement signal. This also applies when the wireless communication device 130 detects a movement and starts to send an uplink measurement signal. This is refereed as UL measurement-based mobility procedure.

Action 304

The network node 120/122/140 may initiate a serving link change for the wireless communication device 130 based on the mobility measurement information.

After the network node 120/122/140 determines that a beam switch or access node handover is to be performed, the handover or beam switch procedure may be performed according to any of possible prior art procedures.

In above described embodiments, the movement-based trigger may activate reference signal (RS) transmission for serving beam quality monitoring. In other embodiments, it may activate RS transmissions in the serving and candidate beams. Therefore the method may further comprise activating mobility procedure in candidate access nodes or in candidate beams.

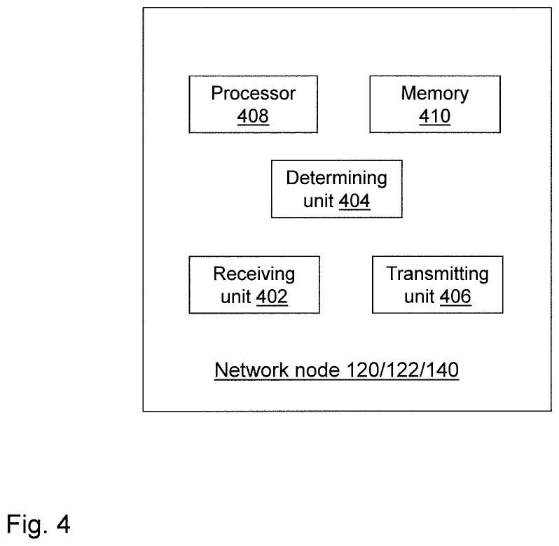

To perform the method actions in the network node, e.g. the serving access node 120, the target access node 122 or the network controller 140, for activation of mobility procedure for a wireless communication device 130 in the wireless communication network 100 described above in relation to FIG. 3, the network node 120/122/140 comprises circuits or units as depicted in FIG. 4. The network node 120/122/140 comprises e.g. a receiving unit 402, a determining unit 404, a transmitting unit 406, a processor 408 and a memory 410.

The network node 120/122/140 is configured to, e.g. by means of the receiving unit 402 being configured to, obtain movement status information of the wireless communication device 130.

There are several ways to obtain movement status information of the wireless communication device 130:

According to one embodiment, the network node 120/122/140 may be configured to, e.g. by means of the receiving unit 402 being configured to, receive the movement status information from the wireless communication device 130.

According to one embodiment, the node network node 120/122/140 may be configured to, e.g. by means of the determining unit 404 being configured to, determine movement status of the wireless communication device 130 based on channel estimates of received signals from the wireless communication device 130.

According to one embodiment, the network node 120/122/140 may be configured to, e.g. by means of the determining unit 404 being configured to, determine movement status of the wireless communication device 130 based on signal strength measurement reports with regard to one or more network access nodes received from the wireless communication device 130.

According to one embodiment, the network node 120/122/140 may be configured to, e.g. by means of the determining unit 404 being configured to, determine movement status of the wireless communication device 130 based on timing advance estimates of the wireless communication device 130 with regard to one or more network access nodes.

The network node 120/122/140 is further configured to, e.g. by means of the determining unit 404 being configured to, activate mobility procedure based on the movement status information.

There are several ways to activate mobility procedure:

According to one embodiment, the network node 120/122/140 may be configured to send a downlink mobility measurement signal to the wireless communication device 130.

According to one embodiment, the network node 120/122/140 may be configured to order the wireless communication device 130 to transmit an uplink mobility measurement signal.

According to one embodiment, the network node 120/122/140 may be configured to receive an uplink mobility measurement signal from the wireless communication device 130.

According to one embodiment, the network node 120/122/140 may be configured to request the wireless communication device 130 to send measurement report in case the downlink mobility measurement signals are already or always on.

According to some embodiments, the network node 120/122/140 may be further configured to obtain mobility measurement information and initiate a serving link change for the wireless communication device 130 based on the mobility measurement information. The network node 120/122/140 may be configured to receive mobility measurement information from the wireless communication device 130 or measure the uplink mobility measurement signal received from the wireless communication device.

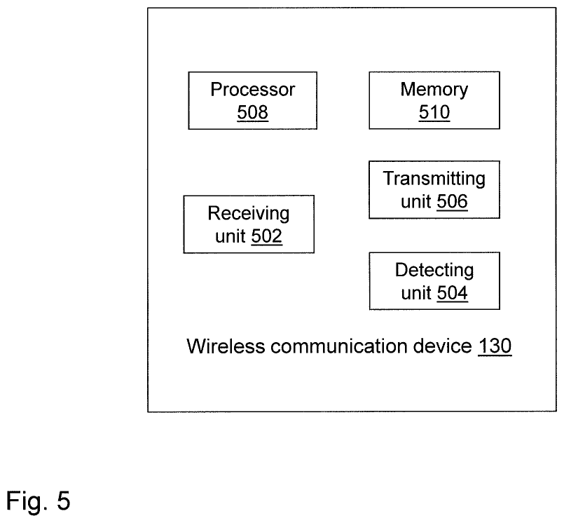

To perform the method actions in the wireless communication device 130, i.e. the network node is a wireless communication device, for activation of mobility procedure in the wireless communication network 100 described above in relation to FIG. 3, the wireless communication device 130 comprises circuits or units depicted in FIG. 5. The wireless communication device 130 comprises a receiving unit 502, a detecting unit 504, a transmitting unit 506, a processor 508, a memory 510.

To obtain movement status in the wireless communication device 130, the wireless communication device 130 may be configured to, e.g. by means of, the detecting unit 504 being configured to, detect movement status in the wireless communication device 130.

The wireless communication device 130 may be configured to detect a change in position, speed, or in environmental or proximity parameters of the wireless communication device 130.

The wireless communication device 130 may be configured to detect movement status based on received signals from an access node 120/122.

The wireless communication device 130 may be configured to detect any one of a Doppler spread or a vehicular speed, a static or a movement state, based on down link channel estimates in the wireless communication device.

The detecting unit 504 may be a sensor, such as an accelerometer, a gyroscopes, an optical and electrical sensor etc.

To activate mobility procedure, the wireless communication device 130 may be configured to, e.g. by means of the transmitting unit 506 being configured to, send an uplink mobility measurement signal when the detected movement status indicates a movement or when the mobility extent indicator is above a predefined threshold.

In case downlink mobility measurement signals are already or always on, the wireless communication device 130 may be configured to activate mobility procedure by activating measurement reporting to the network node 120/122/140.

Those skilled in the art will appreciate that the receiving unit 402, the determining unit 404 and the transmitting unit 406 described above in the network node 120/122/140 may be referred to one circuit/unit, a combination of analog and digital circuits, one or more processors configured with software and/or firmware and/or any other digital hardware performing the function of each circuit/unit. One or more of these processors, the combination of analog and digital circuits as well as the other digital hardware, may be included in a single application-specific integrated circuitry (ASIC), or several processors and various analog/digital hardware may be distributed among several separate components, whether individually packaged or assembled into a system-on-a-chip (SoC). These may also apply to the receiving unit 502, the transmitting unit 506 and the detecting unit 504 described above in the wireless communication device 130.

The embodiments herein for activation of mobility procedure for the wireless communication device 130 in the wireless communication network 100, may be implemented through one or more processors, such as the processor 408 in the network node 120/122/140, the processor 508 in the wireless communication device 130, together with computer program code for performing the functions and actions of the embodiments herein. The program code mentioned above may also be provided as a computer program product, for instance in the form of a data carrier carrying computer program code for performing the embodiments herein when being loaded into the network node 120/122/140 and the wireless communication device 130. One such carrier may be in the form of a CD ROM disc. It is however feasible with other data carriers such as a memory stick. The computer program code may furthermore be provided as pure program code on a server and downloaded to the network node 120/122/140 and the wireless communication device 130.

The memory 410 in the network node 120/122/140 and the memory 510 in the wireless communication device 130 may comprise one or more memory units and may be arranged to be used to store received information, measurements, data, configurations and applications to perform the methods herein when being executed in the network node 120/122/140 and the wireless communication device 130.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

1-42. (canceled)

43. A method performed in a network node for activation of a mobility procedure for a wireless communication device in a wireless communication network, comprising:
obtaining movement status information of the wireless communication device; and
activating reference signal transmission based on the movement status information.

44. The method according to claim 43, wherein the movement status information comprises any one of: a static state, a movement state, and a mobility extent indicator.

45. The method according to claim 44, wherein activating the mobility procedure based on the movement status information comprises activating the mobility procedure when the movement status information indicates a movement or when the mobility extent indicator is above a predefined threshold.

46. The method according to claim 45, wherein the predefined threshold is one of a vehicular speed threshold and a Doppler spread threshold.

47. The method according to claim 43, wherein the network node is any one of a serving access node, a non-serving access node and a network controller.

48. The method according to claim 47, wherein obtaining the movement status information of the wireless communication device comprises:
receiving the movement status information from the wireless communication device.

49. The method according to claim 47, wherein obtaining the movement status information of the wireless communication device comprises any combination of:
determining the movement status of the wireless communication device based on channel estimates of received signals from the wireless communication device;
determining the movement status of the wireless communication device based on signal strength measurement reports with regard to one or more network access nodes received from the wireless communication device; and
determining the movement status of the wireless communication device based on timing advance estimates of the wireless communication device with regard to one or more network access nodes.

50. The method according to claim 43, wherein activating reference signal transmission comprises:
transmitting a downlink mobility measurement signal.

51. The method according to claim 43, wherein activating reference signal transmission comprises:
activating reference signal transmission for serving beam quality monitoring.

52. The method according to claim 43, wherein activating the mobility procedure comprises:
activating reference signal transmission in serving and candidate beams.

53. The method according to claim 43, wherein activating the mobility procedure comprises:
requesting the wireless communication device to send a measurement report.

54. The method according to claim 43, further comprising:
obtaining mobility measurement information; and
initiating a serving link change for the wireless communication device based on the mobility measurement information.

55. The method according to claim 54, wherein obtaining the mobility measurement information comprises:
receiving the mobility measurement information from the wireless communication device.

56. The method according to claim 54, wherein obtaining the mobility measurement information comprises:
measuring an uplink mobility measurement signal received from the wireless communication device.

57. A network node configured for activation of a mobility procedure for a wireless communication device in a wireless communication network, the network node comprising:
processing circuitry operatively associated with the communication circuitry and configured to:
obtain movement status information of the wireless communication device; and
activate the mobility procedure based on the movement status information.

58. The network node according to claim 57, wherein the network node is one of a serving access node, a non-serving access node and a network controller.

59. The network node according to claim 58, wherein the processing circuitry is configured to obtain the movement status information of the wireless communication device by being configured to receive the movement status information from the wireless communication device.

60. The network node according to claim 58, wherein the processing circuitry is configured to obtain the movement status information of the wireless communication device by being configured to:
determine a movement status of the wireless communication device based any combination of:
channel estimates of received signals from the wireless communication device;
signal strength measurement reports with regard to one or more network access nodes received from the wireless communication device; and
timing advance estimates of the wireless communication device with regard to one or more network access nodes.

61. The network node according to claim 58, wherein the processing circuitry is configured to activate the mobility procedure based on the movement status information by being configured to:
transmit a downlink mobility measurement signal.

62. The network node according to claim 58, wherein the processing circuitry is configured to activate the mobility procedure based on the movement status information by being configured to:
order the wireless communication device to transmit an uplink mobility measurement signal.

63. The network node according to claim 58, wherein the processing circuitry is configured to activate the mobility procedure based on the movement status information by being configured to:
receive an uplink mobility measurement signal from the wireless communication device.

64. The network node according to claim 58, wherein the processing circuitry is configured to activate the mobility procedure based on the movement status information by being configured to:
request the wireless communication device to send a measurement report.

65. The network node according to claim 58, wherein the processing circuitry is further configured to:
obtain mobility measurement information; and
initiate a serving link change for the wireless communication device based on the mobility measurement information.

66. The network node according to claim 65, wherein the processing circuitry is configured to obtain the mobility measurement information by being configured to:
receive the mobility measurement information from the wireless communication device or measure an uplink mobility measurement signal received from the wireless communication device.
